(19) United States
(12) Patent Application Publication
(10) Pub. No.: US 2010/0308294 A1
(43) Pub. Date: Dec. 9, 2010

(54) Open and close railgate

(76) Inventor: William Orville Watkins, Washington, DC (US)

Correspondence Address: William O. Watkins, 1512 F. St. N.E. #3, Washington, DC, 20002, US

(21) Appl. No.: 12/382,835

(22) Filed: Jun. 4, 2009

(51) Int. Cl. E06B 11/02; E04H 17/00

(52) U.S. Cl. 256/73; 256/1

(57) ABSTRACT

This is an invention that relates to a movable fence that raises and lowers on any platform adjacent to a swimming pool, metro and or any train. The fence is controlled by a control system operated by user, and is electric and hydraulic powered. This apparatus is a defense against and prevents entry into any area in the up position. With the fence around any swimming pool itself there is no danger of any child or person falling in the swimming pool. When in the up position person standing on a metro or train platform will be prevented from falling on to the train tracks below. The fence in the down position one would have full entry to any area. All fences have safe guards to stop fence movement in case emergency stop is needed.

### CROSS REFERENCE TO RELATED APPICATIONS

This application is a continuation-in-part of Ser. No. 12/382,835, filed Jun. 6, 2009, and Mar. 25, 2009, entitled “Open and Close Railgate System”, applicant name, William O. Watkins.

### BACKGROUND OF THE INVENTION

This invention relates to a moveable defensive apparatus in which a mechanical and hydraulic moveable fence can be altered from a high position or (up position) to a lower position or (down position) and vice versa. This action or movement of the fence will give free access to and from any home un-ground swimming pool, metro or passenger train which makes it safe to stand on their platforms and safe from falling their train tracks below. There have been many deaths in home in-ground swimming pools yearly. Children of all ages, the disabled and the elderly are in the most danger of being injured in a home in-ground swimming pool accident. More than 300-600 people yearly are injured in home in-ground swimming pools accidents. In metro and train station people falling unto the train tracks from the trains platform happen many times annually. Homes with in-ground pools by law, all must have a 6 ft. fence around their homes grounds to keep people from the outside from walking on to their property and falling into their swimming pool. But deaths and accidents from person mostly children, of coming from inside the home, which has no protected fence and children can easily fall into the pool from this open area, this is a serious danger.

### SUMMARY OF THE INVENTION

The object of the invention is to provide a moveable fence with advantages of having a safe area from the danger of any person from falling into an unprotected swimming pool. This invention has a simple, easy and effective operating system. The system makes it safe for recreational use around the swimming pool are& In providing a perimeter security around the pool itself, this will prevent one from gaining access to the other side of the fence. It also, provides a safe platform area for play by children around the pool because there is little danger of falling into the pool. It is desirable for any homeowner to have this device around their pool to lessen the danger of accidental fall into any swimming pool. The ventrally moving fence from the in-ground chamber below position provides a security perimeter safe enough for any non-swimmer from the serious danger of drowning in any swimming pool and the danger of falling onto train tracks from the train platform. This barrier fence in the above ground position or (up position) will prevent one from gaining access to the swimming pool on the other side of the barrier again in the raised above ground position. In surrounding the edge of the swimming pool the height of this fence can be adjusted from ground level to as much as six feet or less as wanted. The fence provides practical and effected protection where unwanted enter into the swimming pool, metro or train station can be prevented.

### BREIEF DESCRIPTION OF THE DRAWING

References for a more complete understanding of the accompanying illustrating drawing for the invention are made more readily understood by the embodiment of the invention.

FIG. 1 is a perspective view of the vertical mounting units, the raises fence incorporated on post set in the below ground level receiving chamber.

FIG. 2 is a cross-sectional view of the fencing elements, hydraulic hoist power assembly. Also, the interconnected are portion of the apparatus.

FIG. 3 is a similar view to FIG. 1 Illustrating the upper crossbar in its uppermost position.

FIG. 4 is a sectional view taken from FIG. 1 and FIG. 3 but in the below ground level receiving chambers.

FIG. 5 is a perspective view similar to FIG. 1 and FIG. 3 illustrating the fence installed in ground making a perimeter around the edges of swimming pool.

### DETAILED DESCRIPTION OF A PREFERRE EMBODIMENT

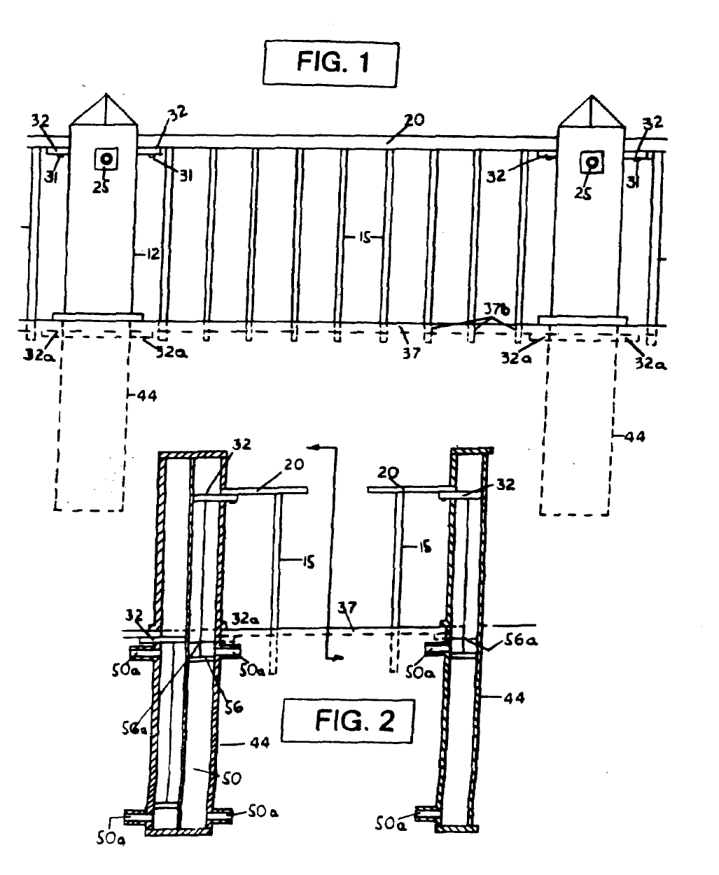

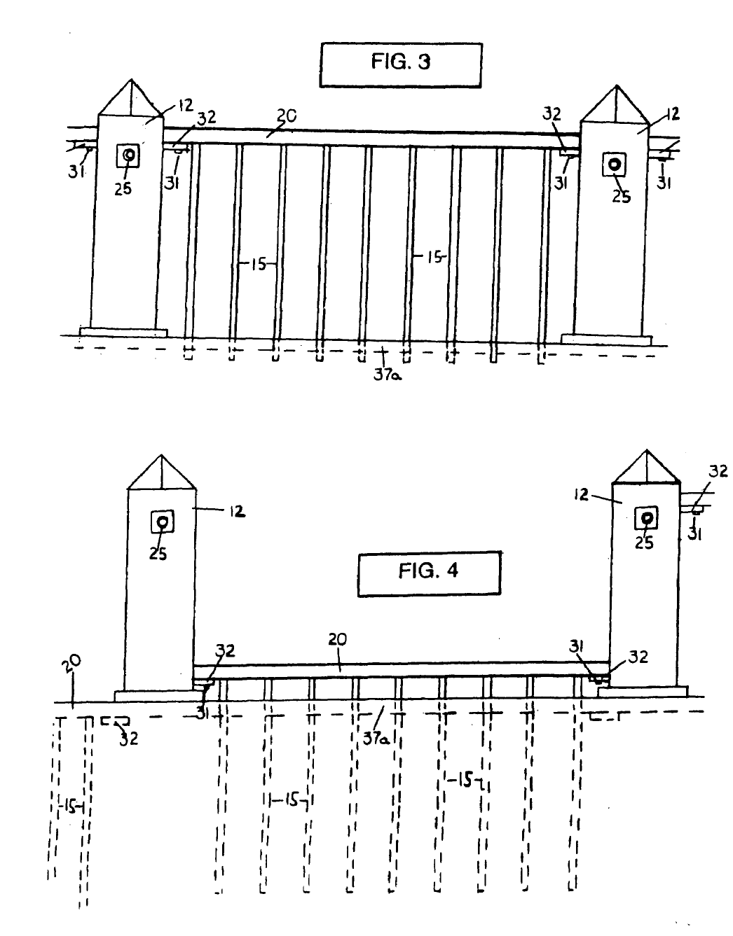

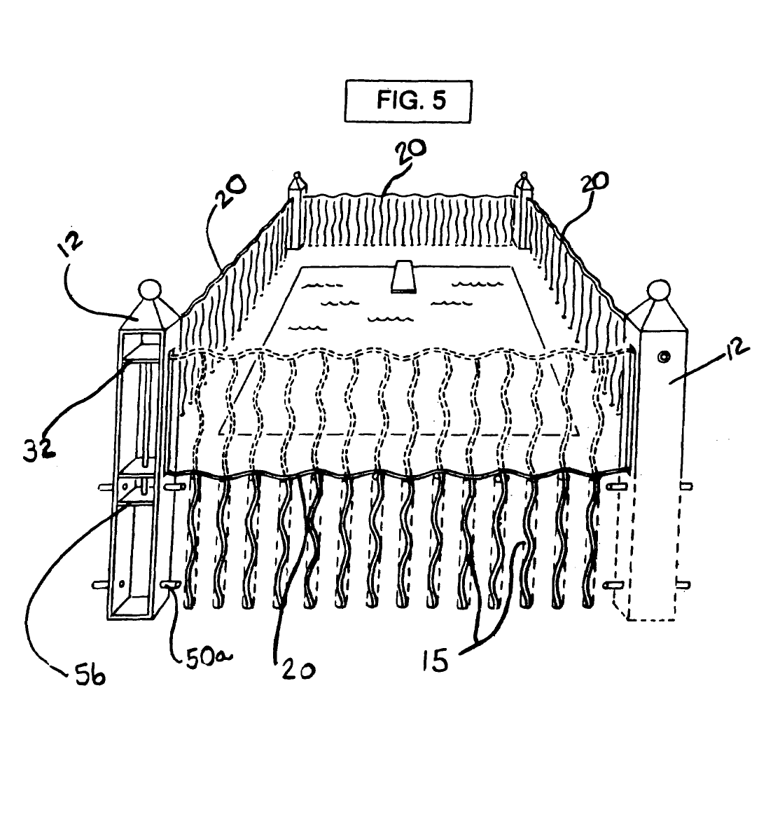

According to the embodiment of the present invention as shown and illustrated shown in FIG. 1 is a moveable fence from a platform to prevent accidentally falling into a swimming pool. This fence in vertical position 12 as well as the other fence units 15 generally connected to an upper crossbar modular fence configuration 20. The lower chamber inserted into ground which is securely anchored at it's base between 44, 12 in a general connecting manner. The fence with vertical post 15 are spaced equally apart as possible, strong durable materials should be used aluminum or lightweight steel. The distance between each rail 15 can be what is preferred row to provide easy guide from inserted ground 37, 37b position to the uppermost position as shown in FIG. 1. Modular fence may be connected together 20, 32 to upper crossbar 20 are connected together by with of screw in bolt and lock washer 31. The lifting process for the height as set is seen in FIG. 1 to height preferred there must be an in-ground chamber or (horizontal channel) 37a, which makes the lifting, process possible. Hollow tubular section for guide columns for rail cylind 15 as shown in FIG. 4 lifts fence to an affected barrier. Lift means is control and raised comprise hydraulically operable lift cylinders as shown in FIG. 4 and FIG. 5. Providing guides in the lower insertion into ground position 37 for cross 20 the width as set FIG. 1 to height preferred there must be an in ground chamber or (horizontal channel) 37a which makes the lifting process possible. Hollow tubular or section for guide columns for rail cylinders 15 as shown in FIG. 4 lifts fence modular to an affected barrier. Lift means is control and raised comprise hydraulically operable lift cylinders as shown in FIG. 4 and FIG. 5. Providing guides in the lower insertion into ground position 37 for crossbar 20 the width of crossbar in lower position. When the fence is lowered to maximum into platform cavity 32a for with post attachment connection 32 is set a width of 32 shown in FIG. 2 and depth of connection 32, 31. A connection occurs with electrically charged control to a light 25 on fence post-housing 12. This controls the lower and upper movement of each fence section as shown in FIG. 5 are each fence section can be set to lower all together and stop if electrically control button is released. The countersink horizontally upper to lower position is the guide post for fence horizontally rail 20. Receiving the upper fence rail 20 is into 37a, 37 as shown in FIG. 1, FIG. 3 The hoist assembly 50a is hydraulically powered via electrically controls with indicator light of fence post 25 for shutoff control button. This control is placed via platform as shown on FIG. 5. The cut-away view of hoist assembly FIG. 2 via power lines 50a is or maybe powered by small electric motor, as required by user. The hoist assembly uppermost position 56 as shown on FIG. 2, FIG. 5 is lowered in the direction of horizontal countersunk configuration 32,32a, 37 preferably securely anchored spacing as shown on FIG. 5 and install in ground around the perimeter of pool.

While preferred in the above embodiment of the fence system invention has been disclosed combines a barrier fence and intrusion sensors it should be understood that various changes, adaptations and medications maybe made without departing from the spirit of the invention and or scope of details of the construction shown may be altered or omitted.

What is claimed:

1. A fencing system providing a perimeter security for swimming pools, metro and train platforms.

2. A moveable fence apparatus that operates vertically having four corners or what is required by user.

3. The fencing system extending the length of the enclosure at that edges to an uppermost position moving in a vertically direction and vise via. But can stored in a count sink hold or cavity on platform of apparatus and a control system coupled with the plurality hydraulically hoists system used to lower and raise the modular fence system in response to user commands.
